(19) United States
(12) Patent Application Publication
(10) Pub. No.: US 2007/0141440 A1
(43) Pub. Date: Jun. 21, 2007

(54) Cylindrical structure fuel cell

(75) Inventors: Hai Yang, Shanghai (CN); Jun Cai, Shanghai City (CN); Jinghua Liu, Shanghai (CN); Chang Wei, Niskayuna, NY (US); Qunjian Huang, Shanghai (CN); Shengxian Wang, Shanghai (CN); Qijia Fu, Shanghai (CN)

Correspondence Address: HAI YANG, 1800 CAILUN ROAD, SHANGHAI, 201203, CN

(73) Assignee: General Electric Company

(21) Appl. No.: 11/314,226

(22) Filed: Dec. 21, 2005

(51) Int. Cl. H01M 8/02; H01M 12/06; H01M 4/94; H01M 4/90

(52) U.S. Cl. 429/38; 429/27; 429/44; 429/42; 429/164

(57) ABSTRACT

A galvanic cell structure is provided. The galvanic cell structure includes an outer cylinder featuring air inlets, a cathode, an anode, a membrane separating the cathode from the anode, and an inner cylinder featuring fluid inlets that may provide a volume for storing and/or transferring fluid for use in the galvanic cell.

### FIELD OF TECHNOLOGY

Embodiments of the invention may relate to a structure of a fuel cell or battery. Embodiments of the invention may relate to a cylindrical structure of a rechargeable fuel cell or metal/air battery.

### BACKGROUND

A fuel cell may convert the chemical energy of a fuel directly into electricity without any intermediate thermal or mechanical processes. Energy may be released when a fuel reacts chemically with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

Fuel cell vehicles may operate on hydrogen stored onboard the vehicles, and may produce little or no conventional undesirable by-products. Neither conventional pollutants nor green house gases may be emitted. The byproducts may include water and heat. Systems that rely on a reformer on board to convert a liquid fuel to hydrogen produce small amounts of emissions, depending on the choice of fuel. Fuel cells may not require recharging, as an empty fuel canister could be replaced with a new, full fuel canister.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal/air batteries have been used in hearing aids and in marine applications, for example.

It may be desirable to have a fuel cell and/or a metal/air battery having differing characteristics, structures, or properties than those currently available.

### BRIEF DESCRIPTION

The embodiments of the invention relate to a galvanic cell structure that includes an outer cylinder. Air inlets extend though walls of the cylinder. The structure further includes a cathode, an anode, a membrane separating the cathode from the anode, and an inner cylinder. An inner surface of a wall of the inner cylinder defines a volume. Fluid inlets extend through the wall of the cylinder. The volume may provide for the storage or transport of fluid in the galvanic cell.

### BRIEF DESCRIPTION OF THE DRAWINGS

Reference to the following description, and to the accompanying drawings, may be made to illustrate embodiments of the invention. In the drawings:

FIG. 1 illustrates a perspective view depicting a galvanic cell structure, according to some embodiments of the invention.

FIG. 2 illustrates a cross-sectional view depicting a galvanic cell structure, according to some embodiments of the invention.

FIG. 3 illustrates a cross-sectional view depicting a galvanic cell with third electrode, according to some embodiments of the invention.

FIG. 4 illustrates an exploded view depicting an experimental setup to test electrolyte movement through an anode, according to some embodiments of the invention.

FIG. 5 illustrates a graphical view depicting the results of discharge characteristics of an example according to an embodiment of the invention.

### DETAILED DESCRIPTION

Embodiments of the invention may relate to a structure of a fuel cell or battery. Embodiments of the invention may relate to a cylindrical structure of a rechargeable fuel cell or metal/air battery.

References in the specification to “one embodiment”, “an embodiment”, “an example embodiment,” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The embodiments of the present invention relate to a structure for a rechargeable fuel cell or metal/air battery.

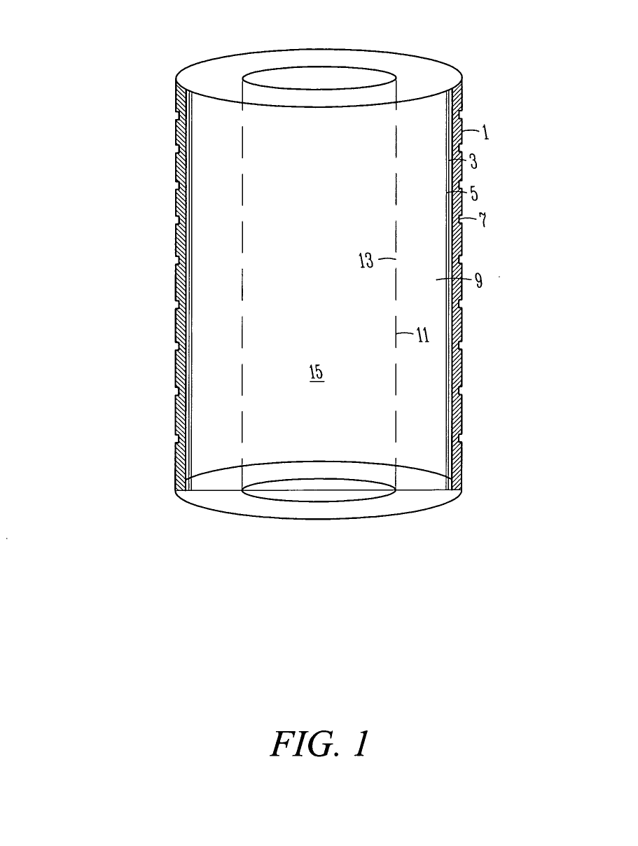

Referring to FIG. 1, a galvanic cell structure is shown. An outer cylinder 1 includes a wall with an inner surface and an outer surface. Air inlets 7 extend through the wall of the outer cylinder 1. The outer cylinder 1 at least partially encloses a cathode 3, a membrane 5, and an anode 9. The cathode 3 may be in contact with the membrane 5. Contact may include direct electrical/physical contact or electrical contact through an optional conductive intermediate layer (not shown). The anode 9 surrounds at least a portion of an inner cylinder 11.

The inner cylinder 11 includes a wall having an outer surface and an inner surface. The anode 9 may be supported on the outer surface, and the inner surface may define a volume that is capable of being filled with a fluid 15. Fluid inlets 13 extend through the wall of the inner cylinder 11.

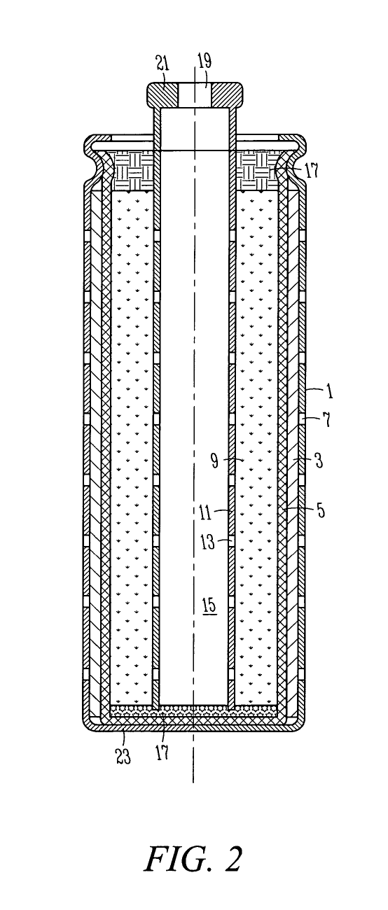

Referring to FIG. 2, a cross sectional view of a galvanic cell structure is shown. The embodiment illustrated in FIG. 2 has many components that are substantially the same as corresponding parts of the embodiment shown in FIG. 1. This is indicated by the use of the same reference numbers for such corresponding parts in the Figs.

An outer cylinder 1 includes air inlets 7 that extend through the outer cylinder wall. The outer cylinder encloses a cathode 3, a membrane 5, and an anode 9. The cathode 3 may be in contact with the membrane 5. The anode 9 surrounds an inner cylinder 11.

The inner cylinder 11 has one or more fluid inlets 13. The inner cylinder 11 has a wall with an outer surface that may support the anode 9, and an inner surface that defines a volume capable of enclosing a fluid 15.

Optionally, the cell structure may include one or more insulator fillers 17, and/or a water-filling cap 19. The water-filling cap 19 may be operated such that a fluid, such as water, can flow into, or be re-filled inside of, the inner cylinder volume. The filling may be in response to a determined water burn rate, a pressure sensor indication that water pressure has dropped, a conductivity sensor indication that sufficient water is not present, or some other sensor that may indicate that water is needed. The water may be consumed during operation, for example, via evaporation.

An anode current collector 21 and cathode current collector 23 may be included in the galvanic cell. In one embodiment, the current collector may include a plurality of flat wires that may span peaks of ribs of the separator. The flat wires may be of sufficient thickness, width, and frequency to support the electrode against a compressive load of a fuel cell stack. The width and frequency may be selected to suppress or enhance reactant access to a corresponding electrode. Electroplating a stainless steel alloy with nickel may produce a suitable current collector. Such a plated electrode may provide for corrosion protection in, for example, an anode current collector application.

The outer cylinder 1 encloses the internal structure of the galvanic cell. The air inlets 7 allow for the passage of air, which supplies oxygen, through the outer cylinder wall and into the cell. That is, the air inlets 7 may serve as oxygen channels. The oxygen can flow from the ambient atmosphere into the outer cylinder 1 and to the cathode 3 during discharge. The air inlets 7 may serve to release generated oxygen out of the outer cylinder 1 during charge. The oxygen in the air may acts as an oxidant at the cathode 3. The outer cylinder 1 may be manufactured of a material stable in an alkaline environment. Suitable materials may include stainless steel or plastic. Suitable plastics may include one or more of polyethylene, polypropylene, polyimide, and the like.

The inner cylinder 11 defines the volume in which the fluid 15 may be supplied and/or stored. The fluid inlets 13 allow for the fluid to flow into, or out of the volume, as needed. The inner cylinder 11 can store the initial water/electrolyte fluid for the initial charge and also can store the water/electrolyte fluid produced during discharge. The inner cylinder 11 may be manufactured of a material stable in an alkaline environment, such as stainless steel or plastic. The fluid inlets 13 in the cylinder allow for the passage of a fluid 15. The inner cylinder 11 is hollow and can store water that may be produced by the electrochemical reaction of the cell. The inner cylinder 11 may also be used to store the electrolyte utilized by the galvanic cell.

Suitable water/electrolyte fluid may be a solution, an emulsion, a suspension, or the like. A suitable fluid may include water. In one embodiment, the fluid is an electrolyte. The electrolyte may be an alkaline electrolyte. Suitable alkaline electrolytes may include one or more of sodium hydroxide, hydrogen peroxide, or potassium hydroxide. If the fluid includes a suspension of particles, the suspended particles may include one or more of ceria, yttria, gadolinium, samarium, or scandia.

A reaction mechanism of a rechargeable fuel cell or metal/air battery is shown below:
4 M+4 H₂O+4e⁻←4 MH+4 OH⁻
4 OH⁻←2 H₂O+O₂+4e⁻

During charge, the galvanic cell may consume a polar fluid, such as one or more of alcohols, carbonates, tetrahydrofuran (THF), or water. During discharge, the consumed water/electrolyte should be recovered, theoretically. But, if the water is not fully recovered, for example, due to evaporation the cell may lose water and become water starved.

The volume defined by the inner cylinder 11 allows for management of water produced by the electrochemical reaction of the cell. As water is produced and consumed, the water transfers to and is stored in the volume. The product water stored in the volume may be utilized for other galvanic cell processes, such as membrane hydration.

The cathode 3, or positive electrode, may be a readily reducible substance. The term cathode applies to the electrode where reduction takes place, and in which electrons are accepted. The cathode 3 may include an air electrode having a catalyst layer and a gas diffusion layer. The catalyst layer may include a catalyst, active carbon (or conductive material and/or gas filter), and a binder. The catalyst may be a metal catalyst, metal oxide catalyst or Perovskite catalyst. An example of a binder may be polytetrafluoroethylene (PTFE). The gas diffusion layer may include the active carbon (or conductive material and/or gas filter), and the binder.

The anode 9, or negative electrode, may be a readily oxidizable substance. The term anode 9 applies to the electrode where oxidation takes place, and in which electrons are given up. The anode 9 may include a hydrogen storage-based material. Suitable hydrogen storage-based materials may include a metal hydride. A suitable metal hydride may be LaNi₅. Other suitable metal hydrides may include one or more of AlH₃, SiH₄, LiH, BeH₂, GaH₃, or SbH₃. The anode may be constructed using an active material, such as the metal hydride, a binder and conductive additives. A suitable binder may be a gel mixture of PTFE and carboxymethylcellulose (CMC). In one embodiment, the conductive additive may be carbonyl nickel powder.

The anode 9 may be constructed using an active material, such as the metal hydride, the binder, and one or more conductive additives. The binder may be a gel mixture of PTFE and carboxymethylcellulose (CMC), for example. The conductive additive may be carbonyl nickel powder.

The membrane 5 functions to spatially separate and/or electrically separate the anode 9 from cathode 3. The membrane 5 may be an electrically insulating material, and may have a relatively high ion conductivity. In one embodiment, the membrane may be stable in alkaline environments. Examples of suitable membrane materials may be non-woven polyethylene (PE), polypropylene (PP), composites of PE and PP, asbestos, or nylon. Other suitable membrane materials may include one or more of perfluorinated sulfuric acid resins, perfluorinated, carboxylic acid resins, polyvinyl alcohol, divinyl benezene, styrene-based polymers, and metal salts impregnated articles comprising any of the foregoing.

The galvanic cell structure may be utilized in a fuel cell, such as a rechargeable fuel cell. More specifically, the rechargeable fuel cell may be an alkaline fuel cell. The structure may also be used in batteries, such as a metal/air battery. More specifically, the structure may be utilized in a primary or secondary metal/air battery.

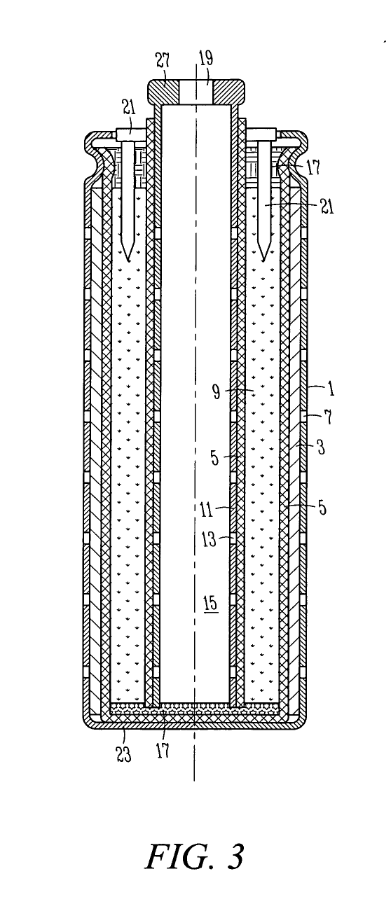

Referring to FIG. 3, a cross-sectional view of a galvanic cell utilizing a third electrode is shown, according to some embodiments of the invention. The structure is comparable to the structure shown in FIG. 2, but with the adoption of a third electrode. The inner cylinder 11 may serve as a third electrode. A third electrode current collector 27 may be utilized with the structure to complete a galvanic cell. A second membrane layer 5 may be placed between the anode 9 and the outer surface of the inner cylinder 11.

The third electrode 11 may be utilized to extend the cycle life relative to traditional structures. The charge process may occur between the anode 9 and the third electrode 11. The discharge process may occur between the anode 9 and the cathode 3. Therefore, the cathode 3 may have reduced exposure to, and be free from, damage during the oxygen evolution reaction.

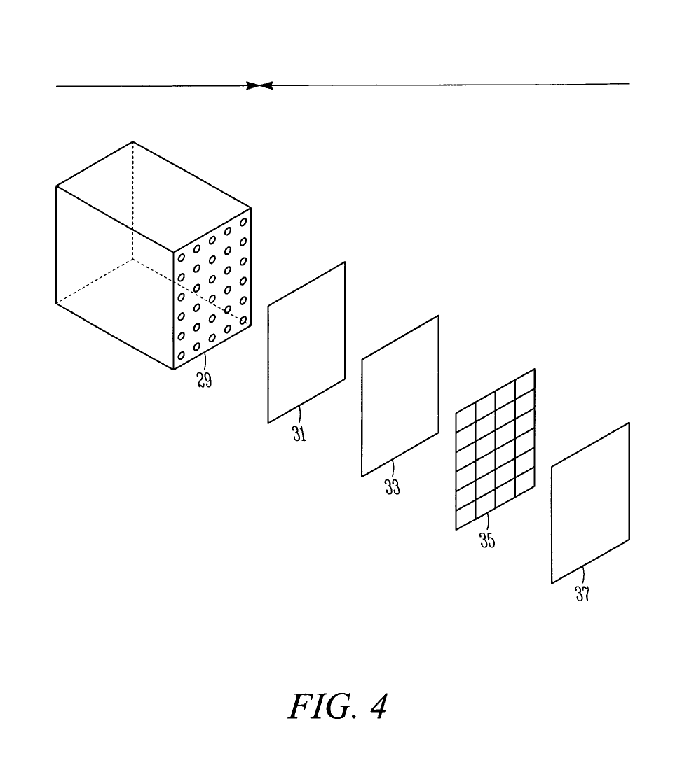

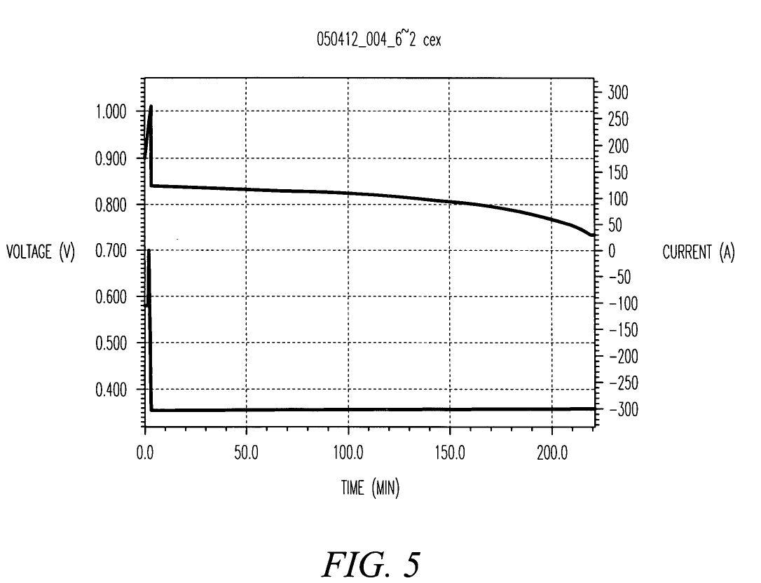

Referring to FIG. 4, a diagram depicting an experimental setup to test electrolyte movement through an anode is shown. The diagram shows the setup in a disassembled view, with the arrows indicating that the individual components are in contact with one another during the experiment. An anode 31 with capacity of 1.5 Ah may be contacted to the electrolyte container 29. The electrolyte container 29 utilizes one wall with numerous inlets allowing the passage of fluid, such as an electrolyte. For the experiment, the electrolyte container 29 may be manufactured of plastic. The anode 31 is next in contact with a membrane 33. The membrane 33 may include a polyolefin-based composite. The membrane 33 contacts a stainless steel mesh 35 and a cathode 37, respectively. The cathode 37 is an air electrode. The anode 31 may be fully pre-charged. The electrolyte container 29 may be filled with 6 molar (M) electrolyte solution of potassium hydroxide. FIG. 5 shows the discharge performance of the simple cell performed at 300 mA discharge current. The measurement is taken at room temperature and ambient air conditions.

The structure and configuration of elements of the embodiments may relatively increase the working area, increase the cell efficiency, and offer a relatively larger current output. There is reduced need to connect cells in parallel to obtain a desired current.

While the illustrated embodiments show a cylinder, the term cylinder includes sphere, oblate, cubed, rectangular, pyramidal, and polygonal configurations that can define a storage volume. Embodiments of the invention provide a structure that relatively increases packaging efficiency due to the ability to be packaged closely in contact with each other with little negative influence due to oxygen distribution, thus increasing the volumetric energy density for the stack. Further, the structure of the cell may be compatible with one or more commercially available devices and equipment that utilize batteries and fuel cells with a determined exterior shape and size.

The embodiments described herein are examples of compositions, structures, systems and methods having elements corresponding to the elements of the invention recited in the claims. This written description may enable one of ordinary skill in the art to make and use embodiments having alternative elements that likewise correspond to the elements of the invention recited in the claims. The scope thus includes compositions, structures, systems and methods that do not differ from the literal language of the claims, and further includes other compositions, structures, systems and methods with insubstantial differences from the literal language of the claims. While only certain features and embodiments have been illustrated and described herein, many modifications and changes may occur to one of ordinary skill in the relevant art. The appended claims are intended to cover all such modifications and changes.

1. A galvanic cell structure, comprising:
an outer cylinder, wherein the outer cylinder has one or more air inlets that extend from outside the outer cylinder through an outer cylinder wall and into an interior of the outer cylinder;
a cathode;
an anode capable of being in electrical communication with the cathode;
a membrane separating the cathode from the anode; and
an inner cylinder, wherein the inner cylinder has one or more fluid inlets that extend from outside the inner cylinder through an inner cylinder wall and into an interior of the inner cylinder, and the inner cylinder has an inner surface that defines a volume capable of one or more of storing fluid or transferring fluid through the one or more fluid inlets.

2. The galvanic cell structure of claim 1, wherein the galvanic cell is a rechargeable fuel cell.

3. The rechargeable fuel cell structure of claim 2, wherein the rechargeable fuel cell is an alkaline fuel cell.

4. The galvanic cell structure of claim 1, wherein the galvanic cell is a metal/air battery.

5. The galvanic cell structure of claim 1, wherein the cathode is an air electrode and comprises a catalyst layer and a gas diffusion layer.

6. The galvanic cell structure of claim 5, wherein the catalyst layer comprises a catalyst, active carbon, and a binder.

7. The galvanic cell structure of claim 6, wherein the catalyst is selected from the group comprising metal catalyst, metal oxide catalyst, and Perovskite catalyst.

8. The galvanic cell structure of claim 5, wherein the gas diffusion layer comprises active carbon and a binder.

9. The galvanic cell structure of claim 1, wherein the anode comprises an active material, a binder, and at least one conductive additive.

10. The galvanic cell structure of claim 9, wherein the active material is a metal hydride.

11. The galvanic cell structure of claim 10, wherein the metal hydride comprises one or more of LaNi₅, AlH₃, SiH₄, LiH, BeH₂, GaH₃, or SbH₃.

12. The galvanic cell structure of claim 9, wherein the binder comprises polytetrafluoroethylene (PTFE), carboxymethylcellulose (CMC), or a mixture thereof.

13. The galvanic cell structure of claim 9, wherein the conductive additive comprises carbonyl nickel powder.

14. The galvanic cell structure of claim 1, wherein the fluid is an electrolyte.

15. The galvanic cell structure of claim 14, wherein the electrolyte is an alkaline electrolyte.

16. The galvanic cell structure of claim 1, wherein the fluid is water.

17. The galvanic cell structure of claim 1, wherein the membrane comprises a separator that is capable of electrical insulation, ion-exchange conductivity, and is stable in alkaline environments.

18. The galvanic cell structure of claim 17, wherein the separator is porous or non-woven.

19. The galvanic cell structure of claim 17, wherein the separator comprises a polyolefin.

20. The galvanic cell structure of claim 17, wherein the separator comprises nylon or asbestos.

21. The galvanic cell structure of claim 1, wherein the outer cylinder comprises a material stable in alkaline environments.

22. The galvanic cell structure of claim 21, wherein the outer cylinder comprises stainless steel.

23. The galvanic cell structure of claim 21, wherein the outer cylinder comprises a thermoplastic.

24. The galvanic cell structure of claim 1, wherein the inner cylinder comprises a material stable in alkaline environments.

25. The galvanic cell structure of claim 24, wherein the inner cylinder comprises stainless steel.

26. The galvanic cell structure of claim 24, wherein the inner cylinder comprises a thermoplastic.

27. The galvanic cell structure of claim 1, wherein one or both of the inner cylinder or the outer cylinder are polygonal.

28. An electronic system, comprising:
means for housing components of a fuel cell or battery and for providing oxidant to an electrode;
a plurality of electrodes disposed within the housing means, wherein the plurality of electrodes comprises at least one of a cathode and an anode;
means for separating the cathode from the anode; and
means for defining a volume within the housing means and for communicating fluid between the volume and at least one of the plurality of electrodes.

29. The electronic system as defined in claim 28, wherein the means for defining a volume within the housing means and for communicating fluid between the volume and at least one of the plurality of electrodes is further capable of receiving and storing the fluid.

30. A galvanic cell structure comprising:
an outer cylinder, wherein the outer cylinder has one or more air inlets that extend from outside the outer cylinder through an outer cylinder wall and into an interior of the outer cylinder;
a plurality of electrodes comprising at least a cathode, an anode, and a third electrode;
a first membrane separating the cathode from the anode;
an inner cylinder, wherein the inner cylinder has one or more fluid inlets that extend from outside the inner cylinder through an inner cylinder wall and into an interior of the inner cylinder, and the inner cylinder has an inner surface that defines a volume capable of one or more of storing fluid or transferring fluid through the one or more fluid inlets; and
a second membrane, wherein the second membrane separates the anode from the inner cylinder.

31. The galvanic cell structure of claim 30, wherein the inner cylinder is capable of functioning as the third electrode.
